(19) United States
(12) Patent Application Publication
(10) Pub. No.: US 2013/0052486 A1
(43) Pub. Date: Feb. 28, 2013

(54) MAGNETIC RECORDING MEDIUM

(71) Applicant: Shinji UCHIDA, Matsumoto-city (JP)

(72) Inventor: Shinji UCHIDA, Matsumoto-city (JP)

(73) Assignee: FUJI ELECTRIC CO., LTD., Kawasaki-shi (JP)

(21) Appl. No.: 13/569,720

(22) Filed: Aug. 8, 2012

(30) Foreign Application Priority Data
Aug. 24, 2011 (JP) 2011-182586

(51) Int. Cl. G11B 5/667; G11B 5/66

(52) U.S. Cl. 428/828.1; 428/827

(57) ABSTRACT

A magnetic recording medium has both satisfactory SNRs at high frequencies and satisfactory squash resistance, and is suitable for higher density recording. The magnetic recording medium includes at least a soft magnetic underlayer and a magnetic recording layer on a non-magnetic substrate. The soft magnetic underlayer includes a first soft magnetic layer, a second soft magnetic layer, an exchange coupling control layer, a third soft magnetic layer, and a fourth soft magnetic layer stacked in this order from the non-magnetic substrate side. The first and fourth soft magnetic layers both have a characteristic frequency of relative permeability higher than a higher one of characteristic frequencies of relative permeability of the second and third soft magnetic layers, and the second and third soft magnetic layers both have a relative permeability higher than a higher one of the relative permeabilities of the first and fourth soft magnetic layers.

### CROSS-REFERENCE TO RELATED APPLICATION

This application claims priority under 35 U.S.C. §119 from Japanese Patent Application No. JP PA 2011-182586, filed on Aug. 24, 2011, the entirety of which is incorporated herein by reference.

### BACKGROUND OF THE INVENTION

1. Field of the Invention

The present invention relates to magnetic recording media used in magnetic recording apparatuses.

2. Description of the Related Art

Due to the ever increasing demands for larger capacities and higher processing speeds of hard disk devices (HDDs), there is a need to further increase the recording densities of magnetic recording media that are incorporated in HDDs. In this trend, perpendicular magnetic recording has been adopted as a technique for data recording on magnetic recording media. The characteristic feature of perpendicular magnetic recording is that recording is done perpendicularly to the in-plane direction of the recording media. The medium used for perpendicular magnetic recording includes at least a magnetic recording layer made of a hard magnetic material having perpendicular magnetic anisotropy, and a soft magnetic underlayer (SUL) that serves to concentrate and direct the magnetic flux emanating from a single-pole head used for data recording to the recording layer.

As shown in FIG. 3, a typical conventional perpendicular magnetic recording system includes a magnetic recording medium 17 and a single-pole head 10. The single-pole head 10 includes a main pole 11, a yoke with a return pole 12, and a coil 13 surrounding the yoke. The magnetic flux 14 emanated from the main pole 11 passes through a magnetic recording layer 15 directly below the main pole and reaches the inside of an SUL 16. The magnetic flux then passes and spreads through the SUL 16, passes through the magnetic recording layer 15 directly below the return pole 12, and returns to the return pole 12. This magnetizes a region of the magnetic recording layer 15 directly below the main pole 11 in a predetermined direction.

Generally, the SUL in a perpendicular magnetic recording medium is formed by two soft magnetic layers separated up and down from each other by an Ru film or the like of about 0.1 nm to 5 nm thickness. The two soft magnetic layers separated up and down are antiferromagnetically coupled to be antiparallel to each other in the radial direction of the medium plane. This is called an antiferromagnetic coupling (AFC) structure. This AFC structure is known to be effective for reducing spike noise caused by magnetic domain boundaries of the SUL and suppressing wide adjacent track erasure (WATE).

With a further increase in the demand for higher density recording in recent years, the problem of reduction in signal-to-noise ratio (SNR) has arisen, which occurs during reading and writing with high recording densities. Generally, the disk rotation speed of the magnetic recording medium is constant irrespective of the recording density, which means signals need to be recorded in shorter cycles for higher density recording. This problem of reduced SNR is attributable to the fact that the magnetization response of the SUL is not correspondingly fast enough to match the frequency that has increased with the higher density recording.

In regard to this issue, Japanese Patent Application Laid-open Nos. H5-282647 and 2000-268341 propose using a soft magnetic oxide, typically ferrite, in the soft magnetic material forming the SUL to reduce eddy current losses in the recording magnetic field at high frequencies and to improve the magnetization response, thereby providing a magnetic recording medium having superior recording capabilities in high recording density regions.

Japanese Patent Application Laid-open No. 2005-328046 discloses a magnetic thin film formed of a first magnetic amorphous phase containing microscopic grains of Fe and Co, and a second amorphous phase containing boron (B) and carbon (C), as a material that achieves both better performance at high frequencies and high saturation magnetization, although the material is not applied to magnetic recording media.

The soft magnetic oxide, typically ferrite, described in Japanese Patent Application Laid-open Nos. H5-282647 and 2000-268341 has a low magnetic saturation level and, to permit the magnetic flux from the head to pass through, it would have to be deposited to such a thickness that was hardly applicable as SUL. The material disclosed in Japanese Patent Application Laid-open No. 2005-328046, when used in a conventional soft magnetic underlayer, was found by the present inventors to be effective in improving desirable SNRs at high frequencies, but also found to cause deterioration of resistance to oblique magnetization (squash resistance), as will be described later.

### SUMMARY OF THE INVENTION

Accordingly, an object of the present invention is to provide a magnetic recording medium capable of satisfying both requirements of SNRs at high frequencies and squash resistance and suitable for higher density recording.

The present invention was devised to solve the above problem, which is solved by the means described below.

The magnetic recording medium of the present invention includes at least a soft magnetic underlayer and a magnetic recording layer on a non-magnetic substrate. The soft magnetic underlayer of the magnetic recording medium has a structure including a first soft magnetic layer, a second soft magnetic layer, an exchange coupling control layer, a third soft magnetic layer, and a fourth soft magnetic layer stacked in this order from a non-magnetic substrate side. The first and fourth soft magnetic layers both have a characteristic frequency of relative permeability (frequency at which the relative permeability drops by 50% of the relative permeability at 10 MHz) higher than a higher one of characteristic frequencies of relative permeability of the second and third soft magnetic layers, and the second and third soft magnetic layers both have a relative permeability higher than a higher one of the relative permeabilities of the first and fourth soft magnetic layers.

In the present invention, the first to fourth soft magnetic layers of the soft magnetic underlayer preferably include

(i) a magnetic material containing Fe and Co, and

(ii) a dopant material containing one or a combination of elements selected from B, C, Ti, Zr, Hf, V, Nb, and Ta.

In the present invention, preferably, the first and fourth soft magnetic layers both have a characteristic frequency of relative permeability of 1000 MHz or more, and the second and third soft magnetic layers both have a relative permeability of 700 or more.

One preferred embodiment of the present invention is a magnetic recording medium including at least a soft magnetic underlayer and a magnetic recording layer on a non-magnetic substrate, the soft magnetic underlayer having a structure including a first soft magnetic layer, a second soft magnetic layer, an exchange coupling control layer, a third soft magnetic layer, and a fourth soft magnetic layer stacked in this order from a non-magnetic substrate side. The magnetic recording medium is characterized in that the first to fourth soft magnetic layers are a combination of soft magnetic layers made of (i) a magnetic material containing Fe and Co, and (ii) a dopant material containing one or a combination of elements selected from B, C, Ti, Zr, Hf, V, Nb, and Ta, and the second and third soft magnetic layers both having a higher proportion of the magnetic material containing Fe and Co than that of both of the first and fourth soft magnetic layers.

In the magnetic recording medium of the preferable embodiment above, the second and third soft magnetic layers of the soft magnetic underlayer have a proportion of the magnetic material containing Fe and Co of 82.5 vol % or more, and the first and fourth soft magnetic layers have a proportion of the magnetic material containing Fe and Co of less than 82.5 vol %.

In the preferred embodiment of the present invention, the first and fourth soft magnetic layers and the second and third soft magnetic layers should preferably be respectively symmetric to about the exchange coupling control layer in magnetic characteristics (characteristic frequency of relative permeability and relative permeability), composition, and thickness.

The present invention can provide a magnetic recording medium satisfying both requirements of desirable SNRs at high frequencies and squash resistance and suitable for higher density recording.

### BRIEF DESCRIPTION OF THE DRAWINGS

FIG. 1 is a diagram illustrating the structure of a perpendicular magnetic recording medium of one Example;

FIG. 2 is a diagram illustrating the structure of an SUL in detail of the perpendicular magnetic recording medium of the Example;

FIG. 3 is a diagram illustrating the structure of a typical conventional perpendicular magnetic recording system; and

FIG. 4A to FIG. 4C illustrate the measurement results of frequency dependence of relative permeability in Examples of the present invention.

### DETAILED DESCRIPTION

The present inventors first fabricated a magnetic recording medium including a soft magnetic layer as an SUL formed by adding a dopant material containing one or a combination of elements including B, C, Ti, Zr, Hf, V, Nb, and Ta to a magnetic material containing Fe and Co, and closely investigated the reading and writing characteristics of the medium. For this investigation, a magnetic recording medium with an SUL formed of a soft magnetic layer consisting only of Fe and Co was prepared as a control specimen for comparative examination. The results revealed that desirable SNRs at high frequencies improved in the SUL made of the soft magnetic material with the dopant material as the proportion of the dopant material was increased, as compared to the control specimen. However, it was also found out that the resistance to oblique magnetization (“squash” resistance) deteriorated at the same time.

Squash resistance is an index of the degree of signal smearing caused by oblique magnetization. More specifically, the magnetic flux from the magnetic head should ideally be perpendicular to the film surface of the magnetic recording layer. In actuality, however, the magnetic flux from the tip of the magnetic head spreads obliquely before reaching the SUL. This spreading magnetic flux results in signal smearing in the cross-track direction. Squash resistance is the index indicating the degree of this signal smearing.

Increasing the proportion of the dopant material mentioned above increases the characteristic frequency of relative permeability of the soft magnetic layer. Therefore it was assumed that desirable SNRs at high frequencies were improved. However, the increase in the proportion of the dopant material also led to general deterioration of the relative permeability of the soft magnetic layer. This supposedly reduced the SUL's capability of drawing in the magnetic flux, allowing the magnetic flux from the head to spread, resulting in deterioration of the squash resistance. In the magnetic recording medium with an SUL made of a soft magnetic layer containing (i) a magnetic material including Fe and Co, and (ii) one or a combination of elements including B, C, Ti, Zr, Hf, V, Nb, and Ta, as described above, there was a trade-off relationship between SNRs at high frequencies and squash resistance, because of which the requirements for reading and writing as a magnetic recording medium could not be satisfied.

Based on the results above, the present inventors conducted extensive research to develop a magnetic recording medium that satisfies both requirements of desirable SNRs at high frequencies and squash resistance and is suitable for higher density recording. The outcome is the magnetic recording medium of the present invention.

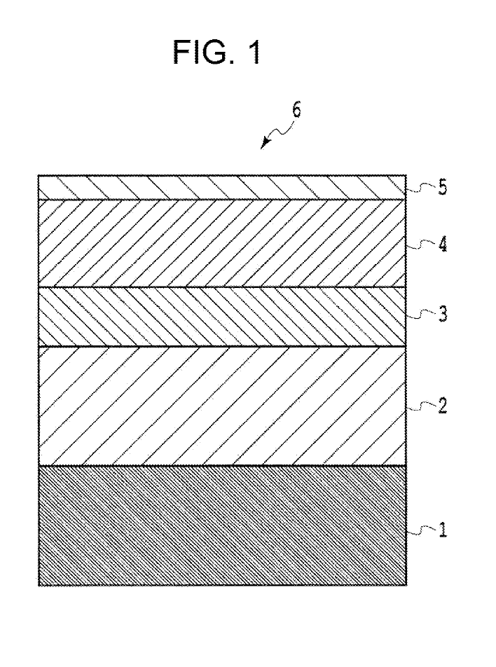

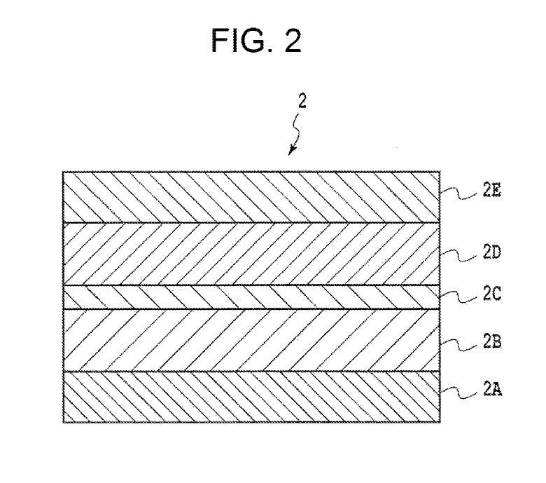

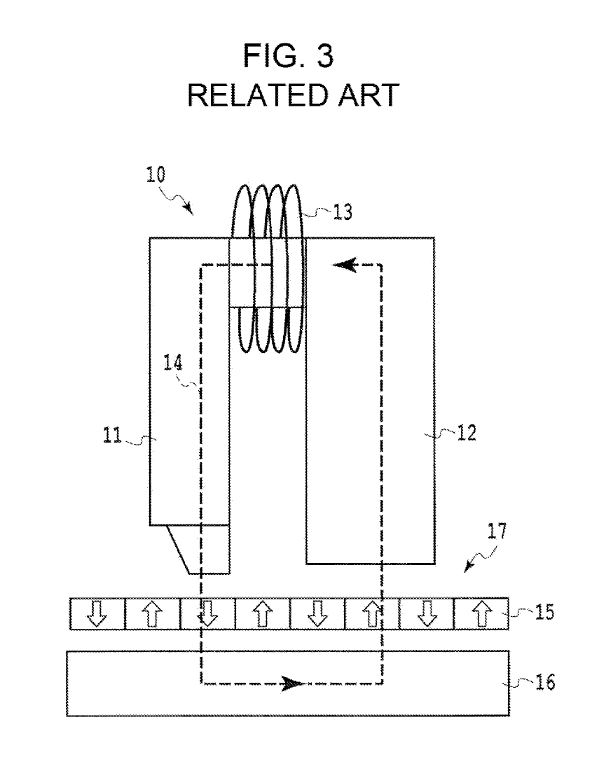

Embodiments of the magnetic recording medium according to the present invention will be described below with reference to FIG. 1 and FIG. 2. FIG. 1 illustrates one example of a magnetic recording medium 6 of the present invention. FIG. 2 illustrates one example of an SUL structure of the present invention.

The magnetic recording medium 6 of the present invention includes at least a non-magnetic substrate 1, a soft magnetic underlayer (SUL) 2, and a magnetic recording layer 4. In the present invention, optionally, the medium may include a underlayer 3, a protective layer 5, and a lubricant layer (not shown) and others. In the present invention, preferably, the medium has a structure in which the non-magnetic substrate 1, SUL 2, underlayer 3, magnetic recording layer 4, protective layer 5, and lubricant layer 6 are stacked sequentially upon one another.

The SUL 2 of the magnetic recording medium according to the present invention has a stacked structure including a first soft magnetic layer 2A, a second soft magnetic layer 2B, an exchange coupling control layer 2C, a third soft magnetic layer 2D, and a fourth soft magnetic layer 2E, the first and fourth soft magnetic layers 2A and 2E having a higher characteristic frequency of relative permeability than the second and third soft magnetic layers 2B and 2D.

The term “characteristic frequency of relative permeability” used herein refers to the frequency at which the relative permeability of the soft magnetic layer is reduced a certain amount from the relative permeability at a specific frequency of that soft magnetic layer. More specifically, the term refers to the frequency at which the relative permeability of the soft magnetic layer is reduced by 50% from the relative permeability at 10 MHz of that soft magnetic layer.

The SUL 2 of the magnetic recording medium according to the present invention is characterized by having the above-described stacked structure and characteristic frequencies of relative permeability. With such improved characteristic frequencies of relative permeability of the soft magnetic layer of the present invention, desirable SNRs at high frequencies can be improved. Magnetic flux at high frequencies passes more readily in a relatively shallow portion of the SUL (portion closer to the magnetic recording layer). With a soft magnetic material with a higher characteristic frequency of relative permeability being disposed as the fourth soft magnetic layer, the magnetic flux is assumed to react well with the fourth soft magnetic layer in the shallow portion of SUL at high frequencies, which, coupled with interaction with the first soft magnetic layer, helps draw in the magnetic flux into the SUL at high frequencies.

While the characteristic frequency of relative permeability of the second and third soft magnetic layers is lower than that of the first and fourth soft magnetic layers, the second and third soft magnetic layers can have a correspondingly higher relative permeability than the first and fourth soft magnetic layers. An increase in overall relative permeability of the SUL is effective for achieving better squash resistance. Thus the improvement in squash resistance presumably resulted from the overall increase in relative permeability of the SUL due to the second and third soft magnetic layers having higher relative permeability than the first and fourth soft magnetic layers.

The characteristic frequencies of relative permeability of the first to fourth soft magnetic layers, and the relationships between the relative permeabilities of the first to fourth soft magnetic layers will be described below in more detail.

In the present invention, the characteristic frequencies of relative permeability of the first and fourth soft magnetic layers 2A and 2E are both higher than the higher one of the characteristic frequencies of relative permeability of the second and third soft magnetic layers 2B and 2D. Namely, the characteristic frequencies of relative permeability of the first and fourth soft magnetic layers 2A and 2E are both higher than the value that is the higher one of the characteristic frequencies of relative permeability of the second and third soft magnetic layers 2B and 2D.

The second and third soft magnetic layers 2B and 2D both have a higher relative permeability than the higher one of the relative permeabilities of the first and fourth soft magnetic layers 2A and 2E. Namely, the relative permeabilities of the second and third soft magnetic layers 2B and 2D are both higher than the value that is the higher one of the relative permeabilities of the first and fourth soft magnetic layers 2A and 2E.

As described above, in the present invention, the SUL 2 has a stacked structure including a first soft magnetic layer 2A, a second soft magnetic layer 2B, an exchange coupling control layer 2C, a third soft magnetic layer 2D, and a fourth soft magnetic layer 2E, with the relationships between the characteristic frequencies of relative permeability and the relative permeabilities (at 100 MHz) of the first and fourth soft magnetic layers 2A and 2E and those of the second and third soft magnetic layers 2B and 2D being set as described above. Thereby, a magnetic recording medium with squash resistance and SNR both improved can be provided.

In the present invention, the magnetic material is preferably Fe—Co based. However, the above discussion applies also to SULs prepared with magnetic materials commonly used for perpendicular magnetic recording media other than Fe—Co. Therefore, those skilled in the art will obviously understand that the present invention is applicable also to iron-based transition metal alloys similar to the Fe—Co system, preferably materials containing Fe, Co, Ni, and Cr.

Next, the materials for the magnetic recording medium of the present invention will be described.

For the non-magnetic substrate 1, NiP-plated Al alloy or glass, crystallized glass, or Si, commonly used in magnetic recording media, may be used.

The soft magnetic underlayer (SUL) 2 is a layer provided for controlling the magnetic flux from the magnetic head to improve the reading and writing characteristics as in currently used perpendicular recording systems. An optimal total thickness of the soft magnetic underlayer 2 depends on the structure and characteristics of the magnetic head used for the magnetic recording. If it is formed by film deposition continuously with other layers, the thickness would desirably be 10 nm or more and 100 nm or less, from a manufacturing point of view.

In the present invention, the SUL 2 has a stacked structure including a first soft magnetic layer 2A, a second soft magnetic layer 2B, an exchange coupling control layer 2C, a third soft magnetic layer 2D, and a fourth soft magnetic layer 2E stacked in this order from the non-magnetic substrate side to the magnetic recording layer side, as shown in FIG. 2. The first and second soft magnetic layers 2A and 2B are magnetically coupled antiparallel in the in-plane direction of the medium to the third and fourth soft magnetic layers 2D and 2E via the exchange coupling control layer 2C. Thus the first and second soft magnetic layers 2A and 2B, and the third and fourth soft magnetic layers 2D and 2E form an AFC-SUL structure.

The first to fourth soft magnetic layers of the SUL 2 in the magnetic recording medium of the present invention should preferably be made of a material combining a magnetic material and one or a combination of elements including B, C, Ti, Zr, Hf, V, Nb, and Ta as a dopant material. An example of a magnetic material is an iron-based transition metal alloy. In the present invention, in particular, a magnetic material containing Fe, Co, Ni or Cr and the like is preferable, and a magnetic material containing Fe and Co is particularly preferable. The first and fourth soft magnetic layers 2A and 2E should preferably contain a higher proportion of the dopant material than the second and third soft magnetic layers 2B and 2D. Thereby, while the first and fourth soft magnetic layers 2A and 2E will have a lower relative permeability than the second and third soft magnetic layers 2B and 2D, the characteristic frequency of relative permeability of the layers 2A and 2E will be increased. On the other hand, while the characteristic frequency of relative permeability of the second and third soft magnetic layers 2B and 2D will be lower than that of the first and fourth soft magnetic layers 2A and 2E, the layers 2B and 2D will have a higher relative permeability. With the SUL 2 having such a structure as described above, a magnetic recording medium capable of satisfying both requirements of desirable SNRs at high frequencies and squash resistance and suitable for higher density recording can be provided.

In the present invention, the first and fourth soft magnetic layers 2A and 2E should preferably have the same composition and thickness, and the second and third soft magnetic layers 2B and 2D should preferably have the same composition and thickness. Namely, the compositions and thicknesses of the first and second soft magnetic layers, and the fourth and third soft magnetic layers, should preferably be in a symmetrical relation to each other respectively via the exchange coupling control layer 2C. With the first and fourth soft magnetic layers 2A and 2E having the same composition and thickness, and with the second and third soft magnetic layers 2B and 2D having the same composition and thickness, variations in the same lot of these soft magnetic layers are made the same. This will make the behaviors of the respective two layers above and below the exchange coupling control layer 2C identical and thereby stable AFC is maintained in the SUL 2.

As long as the above specifications are met, the first to fourth layers may each have a multilayer structure.

The respective thicknesses of the first to fourth soft magnetic layers may be determined by desired reading and writing characteristics, and may be identical to or different from each other. For example, the first soft magnetic layer 2A should preferably have a thickness of 5 nm to 30 nm, the second soft magnetic layer 2B should preferably have a thickness of 5 nm to 30 nm, the third soft magnetic layer 2D should preferably have a thickness of 5 nm to 30 nm, and the fourth soft magnetic layer 2E should preferably have a thickness of 5 nm to 30 nm.

The characteristic frequency of relative permeability of the first and fourth soft magnetic layers 2A and 2E is higher than that of the second and third soft magnetic layers 2B and 2D. As explained in the foregoing, the term “characteristic frequency of relative permeability” refers to the frequency at which the relative permeability of a soft magnetic layer is reduced a certain amount from the relative permeability of that layer at a specific frequency. More specifically, the term refers to the frequency at which the relative permeability is reduced by 50% from the relative permeability at 10 MHz. In the present invention, this frequency response should preferably be 1000 MHz or more. A preferable material exhibiting such characteristics for example may contain a magnetic material (Fe—Co) in an amount of less than 82.5 vol %. Examples containing a magnetic material in the amount noted above are specified in the following. One example is a material consisting of 80 vol % of Fe₇₀Co₃₀, 15 vol % of Ta, and 5 vol % of B.

Further, in the present invention, the second and third soft magnetic layers 2B and 2D have a higher relative permeability at 100 MHz or less, than the first and fourth soft magnetic layers 2A and 2E. In the present invention, the second and third soft magnetic layers should preferably have a relative permeability of 700 or more. A preferable material exhibiting such characteristics for example may contain a magnetic material (Fe—Co) in an amount of 82.5 vol % or more. Examples containing a magnetic material in the amount noted above are specified in the following. One example is a material consisting of 85 vol % of Fe₇₀Co₃₀, 12 vol % of Ta, and 3 vol % of B.

The exchange coupling control layer 2C should preferably be made of a material that hardly diffuses to the materials of the non-magnetic substrate 1 and the soft magnetic layers 2A to 2E. Examples of such material include Pt, Pd, and Ru. Ru is particularly preferable. The exchange coupling control layer 2C may have a thickness that allows appropriate antiferromagnetic coupling between the first and second soft magnetic layers 2A and 2B and the third and fourth soft magnetic layers 2D and 2E, which is, for example, preferably about 0.1 nm to 5 nm.

Next, the underlayer 3, which is an optional component, is a layer for (1) controlling the crystal grain diameter and crystal orientation of the magnetic recording layer 4, and for (2) preventing magnetic coupling between the soft magnetic underlayer (SUL) 2 and the magnetic recording layer 4. Therefore the material for the underlayer 3 needs to be selected suitably in accordance with the material of the magnetic recording layer. For example, if the magnetic recording layer 4 directly above the underlayer 3 is made of a material primarily composed of Co and having a hexagonal close-packed (hcp) structure, the material for the underlayer 3 should preferably be selected from those having the same hexagonal close-packed structure or a face-centered cubic (fcc) structure. More specifically, examples of materials for the underlayer 3 include Ru, Re, Rh, Pt, Pd, Ir, Ni, Co, or alloys containing these elements. The thinner the underlayer 3 is, the better the writing performance will be. However, taking account of the functions (1) and (2) mentioned above, the underlayer 3 needs a certain thickness. In the present invention, the underlayer 3 should preferably have a thickness in the range of 3 nm to 30 nm.

The magnetic recording layer 4 should preferably be made of a crystalline magnetic material. A preferable example of material for the magnetic recording layer 4 is a ferromagnetic alloy material containing Co and Pt. The ferromagnetic material needs to have an easy magnetization axis oriented toward a direction in which the magnetic recording is performed. For example, for the perpendicular magnetic recording, the easy magnetization axis of the material for the magnetic recording layer 4 (e.g., c-axis of an hcp structure) needs to be oriented perpendicularly to the surface of the magnetic recording medium (i.e., main plane of the non-magnetic substrate).

Alternatively, the magnetic recording layer 4 may preferably have a structure in which magnetic crystal grains are separated by a non-magnetic spacer. In this case the magnetic crystal grains should preferably be primarily composed of magnetic elements such as Co, Fe, and Ni and have a columnar shape with a diameter of several nm. More specifically, the magnetic crystal grains should preferably be of a material composed of a Co-Pt alloy with metals such as Cr, B, Ta, W added thereto. The non-magnetic spacer should preferably have a thickness of subnanometer. The non-magnetic spacer should preferably be an oxide or a nitride of Si, Cr, Co, Ti, or Ta.

The magnetic recording layer 4 may be formed by any conventional film deposition method. For example, a magnetron sputtering method may be used.

In the present invention, the layers should preferably have a structure in which an epitaxial film of magnetic crystal grains is grown on crystalline portions of the underlayer 3 such that the above-mentioned non-magnetic spacer is located on the grain boundary of the underlayer 3.

The magnetic recording layer 4 may have a conventional thickness, which may be, preferably, 5 nm to 20 nm.

The protective layer 5 may be made of any of conventionally used materials. For example, a material primarily composed of carbon may be used. More specifically, carbon, nitrogen-containing carbon, and hydrogen-containing carbon are preferable. The protective layer may not necessarily be a single layer but may be, for example, a double-layer carbon film consisting of two layers having different properties, or stacked films of metal and carbon, or stacked films of oxide and carbon. The protective layer should preferably have a thickness of, typically, 10 nm or less.

Although not shown in the drawings, a lubricant layer 7 may be formed on the protective layer 5. The lubricant layer 7 serves to prevent wear of the medium surface by being present between the head and the medium when they slide with each other. A fluorine-containing liquid lubricant is suitable as such a material. For example, an organic material represented by: HO—CH₂—CF₂-(CF₂—O)ₘ-(C₂F₄—O)ₙ—CF₂—CH₂—OH (n+m being about 40) may be used. The thickness of the lubricant layer should preferably be set such that the layer can fulfill its function in consideration of the film properties or the like of the protective layer.

The respective layers deposited on the non-magnetic substrate 1 may be formed by various film deposition techniques commonly used in the field of magnetic recording media. For formation of the various layers except for the liquid lubricant layer, as partly mentioned above, DC magnetron sputtering or vacuum deposition may be used for example. The liquid lubricant layer may be formed, for example, by a dipping or spin coating method.

### EXAMPLES

The perpendicular magnetic recording medium of the present invention will be described below in more specific terms based on examples. The present invention should not be limited to these examples as these are merely typical examples suitable for explanation of the perpendicular magnetic recording medium of the present invention.

The magnetic recording medium and the manufacturing method thereof according to the present invention will be hereinafter described in detail using FIG. 1 and FIG. 2 with reference to numbered examples and comparative examples.

### Example 1

In Example 1, a Fe-Co based SUL 2, a underlayer 3 of Ru, a granular magnetic recording layer 4 of CoCrPt—SiO₂, and a protective layer 5 of carbon, and a liquid lubricant layer (not shown) were formed successively on a non-magnetic substrate 1 as shown in FIG. 1 to obtain a perpendicular magnetic recording medium 6. For the liquid lubricant layer, A-20H produced by MORESCO Corporation primarily composed of perfluoropolyether was used. More specifically, the magnetic recording medium was fabricated in the following procedure.

For the non-magnetic substrate 1, a disc-shaped chemically reinforced glass substrate (N-10 produced by HOYA Corporation) having a smooth surface was used.

First, the non-magnetic substrate 1 was introduced into a film deposition apparatus. The films, from SUL 2 to protective layer 5, were all deposited in an in-line film deposition apparatus and not exposed to atmosphere.

The SUL 2 in FIG. 1 was formed to have a stacked SUL structure of FIG. 2 (with layers 2A, 2B, 2C, 2D, and 2E). First, the first soft magnetic layer 2A consisting of 81 vol % of Fe₇₂Co₂₈, 14 vol % of Ta, and 5 vol % of B was formed by DC magnetron sputtering to a thickness of 12 nm in an Ar atmosphere at a degree of vacuum of 1.0 Pa. Next, the second soft magnetic layer 2B consisting of 85 vol % of Fe₇₅Co₂₅, 12 vol % of Ta, and 3 vol % of B was formed at the same vacuum level to a thickness of 9 nm. Next, the exchange coupling control layer 2C made of Ru was formed by DC magnetron sputtering to a thickness of 0.5 nm in an Ar atmosphere at a degree of vacuum of 0.5 Pa. Next, the third soft magnetic layer 2D consisting of 85 vol % of Fe₇₅Co₂₅, 12 vol % of Ta, and 3 vol % of B was formed by DC magnetron sputtering to a thickness of 9 nm in an Ar atmosphere at a degree of vacuum of 1.0 Pa.

Next, at the same degree of vacuum as when forming the third soft magnetic layer 2D, the fourth soft magnetic layer 2E consisting of 81 vol % of Fe₇₂Co₂₈, 14 vol % of Ta, and 5 vol % of B was formed to a thickness of 12 nm.

Successively, as the underlayer 3, an Ru film was formed by DC magnetron sputtering to a thickness of 20 nm in an Ar atmosphere at a degree of vacuum of 1.5 Pa.

Next, the magnetic recording layer 4 was formed. The magnetic recording layer 4 was formed to have a double layer structure. As the first magnetic recording layer, a film consisting of 92 vol % of Co₇₀Cr₁₂Pt₂₅ and 8 vol % of SiO₂ was formed by DC magnetron sputtering to a thickness of 8 nm in an Ar atmosphere at a degree of vacuum of 5.0 Pa. Next, as the second magnetic recording layer, a film consisting of 96 vol % of Co₆₈Cr₂₀Pt₁₂ and 4 vol % of SiO₂ was formed by DC magnetron sputtering to a thickness of 8 nm in an Ar atmosphere at a degree of vacuum of 1.2 Pa. Thus the magnetic recording layer 4 of a total thickness of 16 nm was obtained.

Successively, as the protective layer 5, a carbon layer was formed to a thickness of 3 nm by plasma CVD using ethylene as a material gas at a pressure of 0.13 Pa. Thereupon, the substrate 1 with the respective layers described above formed thereon was taken out from the in-line film deposition apparatus.

Lastly, the liquid lubricant layer consisting of perfluoropolyether was formed to a thickness of 2 nm by dipping, thereby to obtain the magnetic recording medium 6.

### Comparative Example 1

The magnetic recording medium of Comparative Example 1 was prepared similarly to the magnetic recording medium of Example 1 except for the SUL.

The SUL 2 of the magnetic recording medium of Comparative Example 1 was formed to have a four-layer structure similarly to the one shown in FIG. 2 except that the first and fourth soft magnetic layers and the second and third soft magnetic layers were inverted respectively, as compared to the SUL of Example 1.

The film deposition procedure of the respective layers of the SUL of Comparative Example 1 will be described below.

First, the first soft magnetic layer 2A consisting of 85 vol % of Fe₇₅Co₂₅, 12 vol % of Ta, and 3 vol % of B was formed by DC magnetron sputtering to a thickness of 9 nm in an Ar atmosphere at a degree of vacuum of 1.0 Pa. Next, the second soft magnetic layer 2B consisting of 81 vol % of Fe₇₂Co₂₈, 14 vol % of Ta, and 5 vol % of B was formed at the same degree of vacuum to a thickness of 12 nm. Next, the exchange coupling control layer 2C consisting of Ru was formed by DC magnetron sputtering to a thickness of 0.5 nm in an Ar atmosphere at a degree of vacuum of 0.5 Pa. Next, the third soft magnetic layer 2D consisting of 81 vol % of Fe₇₂Co₂₈, 14 vol % of Ta, and 5 vol % of B was formed by DC magnetron sputtering to a thickness of 12 nm in an Ar atmosphere at a degree of vacuum of 1.0 Pa. Next, at the same degree of vacuum as when forming the third soft magnetic layer, the fourth soft magnetic layer 2E consisting of 85 vol % of Fe₇₅Co₂₅, 12 vol % of Ta, and 3 vol % of B was formed to a thickness of 9 nm.

### Comparative Example 2

For the magnetic recording medium of Comparative Example 2, the respective layers were formed by the same methods as Example 1 except for the SUL.

For the magnetic recording medium of Comparative Example 2, the SUL was formed to have a stacked structure of a lower soft magnetic layer (soft magnetic layer on the side of the non-magnetic substrate)/exchange coupling control layer/upper soft magnetic layer (soft magnetic layer on the side of the magnetic recording layer).

The film deposition procedure of the respective layers of the SUL of Comparative Example 2 will be described below.

First, the lower soft magnetic layer consisting of 81 vol % of Fe₇₂Co₂₈, 14 vol % of Ta, and 5 vol % of B was formed by DC magnetron sputtering to a thickness of 21 nm in an Ar atmosphere at a degree of vacuum of 1.0 Pa. Next, the exchange coupling control layer consisting of Ru was formed by DC magnetron sputtering to a thickness of 0.5 nm in an Ar atmosphere at a degree of vacuum of 0.5 Pa. Next, the upper soft magnetic layer consisting of 81 vol % of Fe₇₂Co₂₈, 14 vol % of Ta, and 5 vol % of B was formed by DC magnetron sputtering to a thickness of 21 nm in an Ar atmosphere at a degree of vacuum of 1.0 Pa.

### Comparative Example 3

The magnetic recording medium of Comparative Example 3 was fabricated by the same procedure as Comparative Example 2 except for the SUL. For the SUL of the magnetic recording medium of Comparative Example 3, a soft magnetic layer having a composition of 85 vol % of Fe₇₅Co₂₅, 12 vol % of Ta, and 3 vol % of B was formed instead of the soft magnetic layers having the composition of 81 vol % of Fe₇₂Co₂₈, 14 vol % of Ta, and 5 vol % of B in Comparative Example 2.

### Example 2

For the magnetic recording medium of Example 2, the respective layers were formed by the same methods as Example 1 except for the SUL.

The SUL 2 of Example 2 was formed to have the four layer structure shown in FIG. 2. The compositions of the first to fourth soft magnetic layers of the SUL 2 in this example were changed from those of Example 1. More specifically, samples were prepared with varying volume proportions of Fe₇₀Co₃₀ and of the dopant material containing one or a combination of elements including B, C, Ti, Zr, Hf, V, Nb, and Ta. The first to fourth soft magnetic layers all had a thickness of 10 nm.

The compositions of the samples thus prepared are shown in Table 3.

### Example 3

For evaluating the relative permeability and characteristic frequencies of relative permeability, samples were prepared by forming a soft magnetic layer of (Fe₇₀Co₃₀)_{100-x-y}TzₓB_{y} with a thickness of 40 nm and a carbon layer of 3 nm thickness as a protective layer on a disc-shaped chemically reinforced glass substrate with a smooth surface (N-10 produced by HOYA Corporation). The samples were prepared in the in-line film deposition apparatus similarly to Example 1. The soft magnetic layer was formed by DC magnetron sputtering in an Ar atmosphere at a degree of vacuum of 1.0 Pa, while the carbon layer was formed by CVD.

The compositions of the samples thus prepared are shown in Table 4.

### Evaluation

First, the evaluation results of performance of magnetic recording media prepared in Example 1 and Comparative Examples 1 to 3 will be described. Table 1 shows the compositions of the samples prepared in Example 1 and Comparative Example 1, along with the evaluation results of SNR and squash resistance. Table 2 collectively shows the compositions of the samples prepared in Comparative Examples 2 and 3 and the evaluation results of SNR and squash resistance.

The SNR and squash resistance were measured using a spin stand tester, with a commercially available GMR head. The head had a recording track width of 100 nm and a readback track width of 75 nm.

The SNR was determined from the ratio of signal output to noise output when signal was recorded at a recording frequency of 250 MHz. The SNR was rated as “excellent (O)” when it was 10 dB or more, and as “good (Δ)” when it was 9 dB or more and less than 10 dB. The SNR was rated as “no good (x)” when it was less than 9 dB.

The squash resistance is a value obtained by normalizing (comparing) the signal output after recording an AC erase signal fifty times to adjacent tracks on both sides with the signal initially recorded at a frequency of 70 MHz. The squash resistance was rated as “excellent (O)” when it was 60% or more, and as “good (Δ)” when it was 50% or more and less than 60%. The squash resistance was rated as “no good (x)” when it was less than 50%.

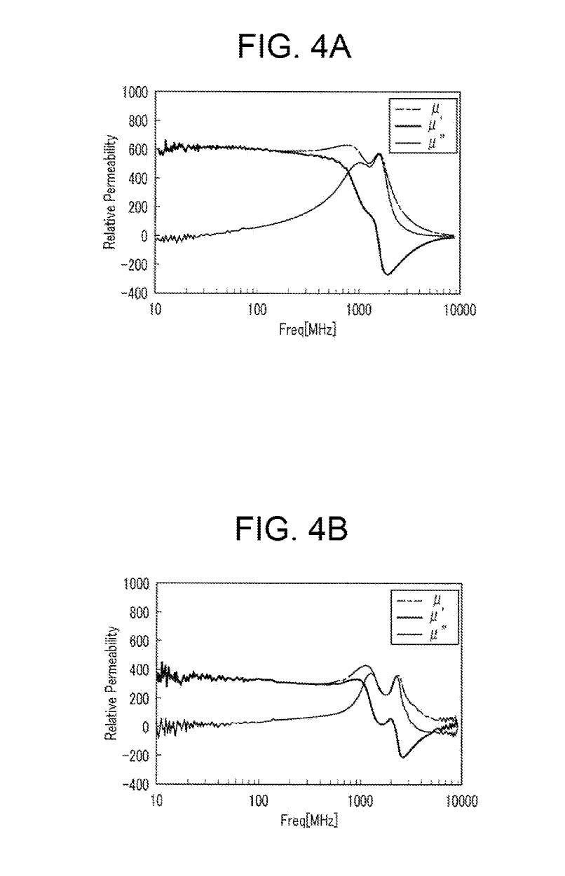

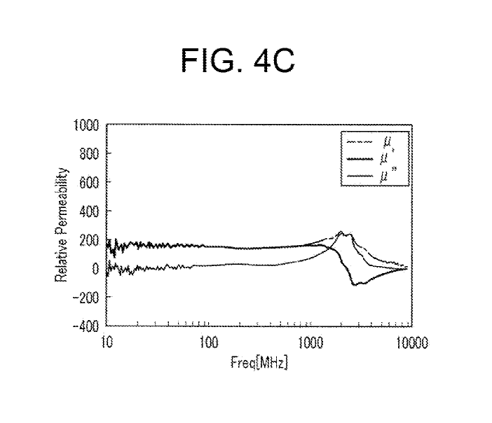

Next, the relative permeability and characteristic frequencies of relative permeability of the samples prepared in Example 3 will be described. FIG. 4A to FIG. 4C illustrate measurement examples of the relative permeability and characteristic frequencies of relative permeability. Table 4 collectively shows the compositions and the relative permeability and characteristic frequencies of relative permeability of the samples prepared in Example 3.

The relative permeability and characteristic frequencies of relative permeability were measured in the range of from 1 MHz to 9 GHz using an apparatus PMM-9G1 produced by Ryowa Electronics Co., Ltd. The relative permeability μ can be measured independently as real part μ′ and imaginary part μ″.

The relative permeabilities and characteristic frequencies of relative permeability in Table 4 were obtained from the real part μ′. The relative permeability was the value at a frequency of 10 MHz, while the characteristic frequency of relative permeability was the frequency at which the relative permeability reduced to half (dropped to 50%) of the value at 10 MHz.

FIG. 4A to FIG. 4C are graphs of measurement results of the soft magnetic layers having the following ones of the compositions shown in Table 4. FIG. 4A shows the measurement results of the soft magnetic layer having a composition of 82 vol % of Fe₇₀Co₃₀, 14 vol % of Ta, and 4 vol % of B. FIG. 4B shows the measurement results of the soft magnetic layer having a composition of 81 vol % of Fe₇₀Co₃₀, 14 vol % of Ta, and 5 vol % of B. FIG. 4C shows the measurement results of the soft magnetic layer having a composition of 80 vol % of Fe₇₀Co₃₀, 15 vol % of Ta, and 5 vol % of B.

TABLE 1

| | First Soft | Second Soft | Third Soft | Fourth Soft | | |
|---|---|---|---|---|---|---|
| Example | Magnetic Layer | Magnetic Layer | Magnetic Layer | Magnetic Layer | Squash | SNR |
| Example 1 | 81 vol % Fe₇₂Co₂₈—14 | 85 vol % Fe₇₅Co₂₅—12 | 85 vol % Fe₇₅Co₂₅—12 | 81 vol % Fe₇₂Co₂₈—14 | ◯ | ◯ |
| | vol % Ta—5 | vol % Ta—3 | vol % Ta—3 | vol % Ta—5 | | |
| | vol % B | vol % B | vol % B | vol % B | | |
| Comparative | 85 vol % Fe₇₅Co₂₅—12 | 81 vol % Fe₇₂Co₂₈—14 | 81 vol % Fe₇₂Co₂₈—14 | 85 vol % Fe₇₅Co₂₅—12 | ◯ | X |
| Example 1 | vol % Ta—3 | vol % Ta—5 | vol % Ta—5 | vol % Ta—3 | | |
| | vol % B | vol % B | vol % B | vol % B | | |

TABLE 2

| Comparative | Lower Soft | Upper Soft | | |
|---|---|---|---|---|
| Example | Magnetic Layer | Magnetic Layer | Squash | SNR |
| Comparative | 81 vol % | 81 vol % Fe₇₂Co₂₈—14 | X | ◯ |
| Example 2 | Fe₇₂Co₂₈—14 | vol % Ta—5 | | |
| | vol % Ta—5 | vol % B | | |
| | vol % B | | | |
| Comparative | 85 vol % | 85 vol % Fe₇₅Co₂₅—12 | ◯ | X |
| Example 3 | Fe₇₅Co₂₅—12 | vol % Ta—3 | | |
| | vol % Ta—3 | vol % B | | |
| | vol % B | | | |

TABLE 3

| | First Soft | Second Soft | Third Soft | Fourth Soft | | |
|---|---|---|---|---|---|---|
| Example | Magnetic Layer | Magnetic Layer | Magnetic Layer | Magnetic Layer | Squash | SNR |
| Example 2-1 | 80 vol % Fe₇₀Co₃₀—15 | 85 vol % Fe₇₀Co₃₀—12 | 85 vol % Fe₇₀Co₃₀—12 | 80 vol % Fe₇₀Co₃₀—15 | ◯ | ◯ |
| | vol % Ta—5 | vol % Ta—3 | vol % Ta—3 | vol % Ta—5 | | |
| | vol % B | vol % B | vol % B | vol % B | | |
| Example 2-2 | 82 vol % Fe₇₀Co₃₀—14 | 83 vol % Fe₇₀Co₃₀—13 | 83 vol % Fe₇₀Co₃₀—13 | 82 vol % Fe₇₀Co₃₀—14 | ◯ | ◯ |
| | vol % Ta—4 | vol % Ta—4 | vol % Ta—4 | vol % Ta—4 | | |
| | vol % B | vol % B | vol % B | vol % B | | |
| Example 2-3 | 82.5 vol % | 82.5 vol % | 82.5 vol % | 82.5 vol % | ◯ | X |
| | Fe₇₀Co₃₀—17.5 | Fe₇₀Co₃₀—17.5 | Fe₇₀Co₃₀—17.5 | Fe₇₀Co₃₀—17.5 | | |
| | vol % Ta | vol % Ta | vol % Ta | vol % Ta | | |
| Example 2-4 | 83 vol % Fe₇₀Co₃₀—13 | 82 vol % Fe₇₀Co₃₀—14 | 82 vol % Fe₇₀Co₃₀—14 | 83 vol % Fe₇₀Co₃₀—13 | ◯ | X |
| | vol % Ta—4 | vol % Ta—4 | vol % Ta—4 | vol % Ta—4 | | |
| | vol % B | vol % B | vol % B | vol % B | | |
| Example 2-5 | 80 vol % Fe₇₀Co₃₀—15 | 83 vol % Fe₇₀Co₃₀—13 | 83 vol % Fe₇₀Co₃₀—13 | 80 vol % Fe₇₀Co₃₀—15 | ◯ | ◯ |
| | vol % Ta—5 | vol % Ta—4 | vol % Ta—4 | vol % Ta—5 | | |
| | vol % B | vol % B | vol % B | vol % B | | |
| Example 2-6 | 80 vol % Fe₇₀Co₃₀—15 | 82 vol % Fe₇₀Co₃₀—14 | 82 vol % Fe₇₀Co₃₀—14 | 80 vol % Fe₇₀Co₃₀—15 | Δ | ◯ |
| | vol % Ta—5 | vol % Ta—4 | vol % Ta—4 | vol % Ta—5 | | |
| | vol % B | vol % B | vol % B | vol % B | | |
| Example 2-7 | 80 vol % Fe₇₀Co₃₀—15 | 80 vol % Fe₇₀Co₃₀—15 | 80 vol % Fe₇₀Co₃₀—15 | 80 vol % Fe₇₀Co₃₀—15 | X | ◯ |
| | vol % Ta—5 | vol % Ta—5 | vol % Ta—5 | vol % Ta—5 | | |
| | vol % B | vol % B | vol % B | vol % B | | |
| Example 2-8 | 80 vol % Fe₇₀Co₃₀—15 | 78 vol % Fe₇₀Co₃₀—16 | 78 vol % Fe₇₀Co₃₀—16 | 80 vol % Fe₇₀Co₃₀—15 | X | ◯ |
| | vol % Ta—5 | vol % Ta—6 | vol % Ta—6 | vol % Ta—5 | | |
| | vol % B | vol % B | vol % B | vol % B | | |
| Example 2-9 | 82.5 vol % | 81 vol % Fe₇₀Co₃₀—14 | 81 vol % Fe₇₀Co₃₀—14 | 82.5 vol % | ◯ | X |
| | Fe₇₀Co₃₀—13.5 | vol % Ta—5 | vol % Ta—5 | Fe₇₀Co₃₀—13.5 | | |
| | vol % Ta—4 | vol % B | vol % B | vol % Ta—4 | | |
| | vol % B | | | vol % B | | |
| Example 2-10 | 82.5 vol % | 82 vol % Fe₇₀Co₃₀—14 | 82 vol % Fe₇₀Co₃₀—14 | 82.5 vol % | ◯ | X |
| | Fe₇₀Co₃₀—13.5 | vol % Ta—4 | vol % Ta—4 | Fe₇₀Co₃₀—13.5 | | |
| | vol % Ta—4 | vol % B | vol % B | vol % Ta—4 | | |
| | vol % B | | | vol % B | | |
| Example 2-11 | 82.5 vol % | 83 vol % Fe₇₀Co₃₀—13 | 83 vol % Fe₇₀Co₃₀—13 | 82.5 vol % | ◯ | Δ |
| | Fe₇₀Co₃₀—13.5 | vol % Ta—4 | vol % Ta—4 | Fe₇₀Co₃₀—13.5 | | |
| | vol % Ta—4 | vol % B | vol % B | vol % Ta—4 | | |
| | vol % B | | | vol % B | | |
| Example 2-12 | 82.5 vol % | 84 vol % Fe₇₀Co₃₀—13 | 84 vol % Fe₇₀Co₃₀—13 | 82.5 vol % | ◯ | Δ |
| | Fe₇₀Co₃₀—13.5 | vol % Ta—3 | vol % Ta—3 | Fe₇₀Co₃₀—13.5 | | |
| | vol % Ta—4 | vol % B | vol % B | vol % Ta—4 | | |
| | vol % B | | | vol % B | | |
| Example 2-13 | 82 vol % Fe₇₀Co₃₀—14 | 85 vol % Fe₇₀Co₃₀—12 | 85 vol % Fe₇₀Co₃₀—12 | 82 vol % Fe₇₀Co₃₀—14 | ◯ | ◯ |
| | vol % Ta—4 | vol % Ta—3 | vol % Ta—3 | vol % Ta—4 | | |
| | vol % B | vol % B | vol % B | vol % B | | |
| Example 2-14 | 83 vol % Fe₇₀Co₃₀—13 | 85 vol % Fe₇₀Co₃₀—12 | 85 vol % Fe₇₀Co₃₀—12 | 83 vol % Fe₇₀Co₃₀—13 | ◯ | Δ |
| | vol % Ta—4 | vol % Ta—3 | vol % Ta—3 | vol % Ta—4 | | |
| | vol % B | vol % B | vol % B | vol % B | | |
| Example 2-15 | 85 vol % Fe₇₀Co₃₀—12 | 85 vol % Fe₇₀Co₃₀—12 | 85 vol % Fe₇₀Co₃₀—12 | 85 vol % Fe₇₀Co₃₀—12 | ◯ | X |
| | vol % Ta—3 | vol % Ta—3 | vol % Ta—3 | vol % Ta—3 | | |
| | vol % B | vol % B | vol % B | vol % B | | |
| Example 2-16 | 87 vol % Fe₇₀Co₃₀—10 | 85 vol % Fe₇₀Co₃₀—12 | 85 vol % Fe₇₀Co₃₀—12 | 87 vol % Fe₇₀Co₃₀—10 | ◯ | X |
| | vol % Ta—3 | vol % Ta—3 | vol % Ta—3 | vol % Ta—3 | | |
| | vol % B | vol % B | vol % B | vol % B | | |
| Example 2-17 | 85 vol % Fe₇₀Co₃₀—12 | 80 vol % Fe₇₀Co₃₀—15 | 80 vol % Fe₇₀Co₃₀—15 | 85 vol % Fe₇₀Co₃₀—12 | ◯ | X |
| | vol % Ta—3 | vol % Ta—5 | vol % Ta—5 | vol % Ta—3 | | |
| | vol % B | vol % B | vol % B | vol % B | | |
| Example 2-18 | 83 vol % Fe₇₀Co₃₀—13 | 80 vol % Fe₇₀Co₃₀—15 | 80 vol % Fe₇₀Co₃₀—15 | 83 vol % Fe₇₀Co₃₀—13 | ◯ | X |
| | vol % Ta—4 | vol % Ta—5 | vol % Ta—5 | vol % Ta—4 | | |
| | vol % B | vol % B | vol % B | vol % B | | |
| Example 2-19 | 81 vol % Fe₇₀Co₃₀—14 | 80 vol % Fe₇₀Co₃₀—15 | 80 vol % Fe₇₀Co₃₀—15 | 81 vol % Fe₇₀Co₃₀—14 | X | ◯ |
| | vol % Ta—5 | vol % Ta—5 | vol % Ta—5 | vol % Ta—5 | | |
| | vol % B | vol % B | vol % B | vol % B | | |
| Example 2-20 | 80 vol % Fe₇₀Co₃₀—15 | 80 vol % Fe₇₀Co₃₀—15 | 80 vol % Fe₇₀Co₃₀—15 | 80 vol % Fe₇₀Co₃₀—15 | X | ◯ |
| | vol % Ta—5 | vol % Ta—5 | vol % Ta—5 | vol % Ta—5 | | |
| | vol % B | vol % B | vol % B | vol % B | | |
| Example 2-21 | 80 vol % Fe₇₀Co₃₀—5 | 85 vol % Fe₇₀Co₃₀—4 | 85 vol % Fe₇₀Co₃₀—4 | 80 vol % Fe₇₀Co₃₀—5 | ◯ | ◯ |
| | vol % Zr—5 | vol % Zr—4 | vol % Zr—4 | vol % Zr—5 | | |
| | vol % Ta—10 | vol % Ta—7 | vol % Ta—7 | vol % Ta—10 | | |
| | vol % Nb | vol % Nb | vol % Nb | vol % Nb | | |
| Example 2-22 | 81 vol % Fe₇₀Co₃₀—5 | 83 vol % Fe₇₀Co₃₀—12 | 83 vol % Fe₇₀Co₃₀—12 | 81 vol % Fe₇₀Co₃₀—5 | ◯ | ◯ |
| | vol % Zr—5 | vol % Ta—5 | vol % Ta—5 | vol % Zr—5 | | |
| | vol % Ta—9 | vol % C | vol % C | vol % Ta—9 | | |
| | vol % Nb | | | vol % Nb | | |
| Example 2-23 | 82 vol % Fe₇₀Co₃₀—5 | 84 vol % Fe₇₀Co₃₀—4 | 84 vol % Fe₇₀Co₃₀—4 | 82 vol % Fe₇₀Co₃₀—5 | ◯ | ◯ |
| | vol % Zr—5 | vol % Zr—4 | vol % Zr—4 | vol % Zr—5 | | |
| | vol % Ta—8 | vol % Ta—8 | vol % Ta—8 | vol % Ta—8 | | |
| | vol % V | vol % Ti | vol % Ti | vol % V | | |
| Example 2-24 | 78 vol % Fe₇₀Co₃₀—16 | 85 vol % Fe₇₀Co₃₀—15 | 85 vol % Fe₇₀Co₃₀—15 | 78 vol % Fe₇₀Co₃₀—16 | ◯ | ◯ |
| | vol % Ta—6 | vol % Ta | vol % Ta | vol % Ta—6 | | |
| | vol % B | | | vol % B | | |
| Example 2-25 | 80 vol % Fe₇₀Co₃₀—5 | 83 vol % Fe₇₀Co₃₀—5 | 83 vol % Fe₇₀Co₃₀—5 | 80 vol % Fe₇₀Co₃₀—5 | ◯ | ◯ |
| | vol % Zr—5 | vol % Zr—5 | vol % Zr—5 | vol % Zr—5 | | |
| | vol % Ta—10 | vol % Ta—7 | vol % Ta—7 | vol % Ta—10 | | |
| | vol % Ti | vol % Ti | vol % Ti | vol % Ti | | |

TABLE 4

| | | Frequency |
|---|---|---|
| | Relative | When |
| | Perme- | Relative |
| | ability | Permeability |
| | (at | Drops |
| Soft Magnetic Layer | 10 MHz) | by 50% |
| 87 vol % Fe₇₀Co₃₀—10 vol % Ta—3 vol % B | 1600 | 25 MHz |
| 85 vol % Fe₇₀Co₃₀—12 vol % Ta—3 vol % B | 1200 | 100 MHz |
| 84 vol % Fe₇₀Co₃₀—13 vol % Ta—3 vol % B | 1050 | 300 MHz |
| 83 vol % Fe₇₀Co₃₀—13 vol % Ta—4 vol % B | 900 | 600 MHz |
| 82.5 vol % Fe₇₀Co₃₀—13.5 vol % Ta—4 | 700 | 800 MHz |
| vol % B | | |
| 82 vol % Fe₇₀Co₃₀—14 vol % Ta—4 vol % B | 600 | 1000 MHz |
| 81 vol % Fe₇₀Co₃₀—14 vol % Ta—5 vol % B | 350 | 1200 MHz |
| 80 vol % Fe₇₀Co₃₀—15 vol % Ta—5 vol % B | 150 | 2000 MHz |
| 78 vol % Fe₇₀Co₃₀—16 vol % Ta—6 vol % B | 100 | 3000 MHz |

The results shown in the tables above are summarized as described below.

First, as seen from the results of Comparative Examples 2 and 3 in Table 2, when all of the four soft magnetic layers of the SUL had the same composition, there was a trade-off relationship between squash resistance and SNR, as a result of which none of the magnetic recording media satisfied both requirements of squash resistance and SNR.

Next, the results of Example 1 in Table 1 showed a contrast to the results in Table 2. Namely, the magnetic recording medium of Example 1 had an SUL with a structure including a first soft magnetic layer, a second soft magnetic layer, an exchange coupling control layer, a third soft magnetic layer, and a fourth soft magnetic layer stacked upon one another in this order from the side of the non-magnetic substrate, the respective soft magnetic layers being made of a magnetic material containing Fe and Co, and a dopant material made of a combination of the elements B and Ta. With this structure, when the proportion of the magnetic material containing Fe and Co of the second and third soft magnetic layers was higher than that of the first and fourth soft magnetic layers, the magnetic recording medium satisfied the requirement of SNR while maintaining squash resistance.

On the other hand, as seen from the results of Comparative Example 1 in Table 1, when the proportion of the magnetic material containing Fe and Co of the second and third soft magnetic layers was lower than that of the first and fourth soft magnetic layers, the magnetic recording medium failed to satisfy the requirement of SNR.

Next, the results shown in Table 3 will be discussed.

In Examples 2-1 to 2-4, the proportion of the magnetic material (Fe₇₀Co₃₀) of the first and fourth soft magnetic layers of the SUL in the magnetic recording medium was progressively increased, and at the same time the proportion of the magnetic material (Fe₇₀Co₃₀) of the second and third soft magnetic layers was reduced.

As seen from the results of Examples 2-1 and 2-2, when the proportion of Fe₇₀Co₃₀ of the first and fourth soft magnetic layers was 82 vol % or less while the proportion of Fe₇₀Co₃₀ of the second and third soft magnetic layers was 83 vol % or more, the magnetic recording medium satisfied both requirements of squash resistance and of SNR. However, when the proportion of Fe₇₀Co₃₀ of all the layers was 82.5 vol % as in Example 2-3, or, when the proportion of Fe₇₀Co₃₀ of the first and fourth soft magnetic layers was 83 vol % or more while the proportion of Fe₇₀Co₃₀ of the second and third soft magnetic layers was 82 vol % or less as in Example 2-4, the SNR was rated as “no good (x)”, while the squash resistance was maintained in the range of being “excellent (O)”. The results of Examples 2-1 to 2-4 also indicate that, when the proportion of Fe₇₀Co₃₀ of either one of the second and third soft magnetic layers, or the first and fourth soft magnetic layers, was 82 vol % or more, the squash resistance was maintained in the range of being “excellent (O)”.

In Examples 2-5 to 2-8 shown in Table 3, while the composition of the first and fourth soft magnetic layers was the same 80 vol % of Fe₇₀Co₃₀, 15 vol % of Ta, and 5 vol % of B, the proportion of Fe₇₀Co₃₀ of the second and third soft magnetic layers was varied from 83 vol % to 78 vol %. Here, since the proportion of Fe₇₀Co₃₀ of the first and fourth soft magnetic layers was 80 vol %, the SNR was maintained in the “excellent (O)” range in all of the Examples 2-5 to 2-8. The SNR and squash resistance were both “excellent (O)” in Example 2-5 where the proportion of Fe₇₀Co₃₀ of the second and third soft magnetic layers was 83 vol %. On the other hand, when the proportion of Fe₇₀Co₃₀ of the second and third soft magnetic layers was reduced to 82 vol % or lower (Examples 2-6 to 2-8), the squash resistance fell out of the “excellent (O)” range while the SNR was maintained “excellent (O)”. Further, when the proportion of Fe₇₀Co₃₀ of the second and third soft magnetic layers was in a range higher than that of the first and fourth soft magnetic layers (Examples 2-5 and 2-6), the squash resistance was maintained “excellent (O)” or “good (Δ)”. However, the squash resistance was rated as “no good (x)” when the proportion of Fe₇₀Co₃₀ of the second and third soft magnetic layers was equal to or in a range lower than that of the first and fourth soft magnetic layers (Examples 2-7 and 2-8).

In Examples 2-9 to 2-12, while the composition of the first and fourth soft magnetic layers was the same 82.5 vol % of Fe₇₀Co₃₀, 13.5 vol % of Ta, and 4 vol % of B, the proportion of Fe₇₀Co₃₀ of the second and third soft magnetic layers was varied from 81 vol % to 84 vol %. Here, while the squash resistance was maintained in the “excellent (O)” range in all of the Examples 2-9 to 2-12, the SNR fell out of the “excellent (O)” range. This is assumed to be correlated with the fact that the proportion of Fe₇₀Co₃₀ of the first and fourth soft magnetic layers was 82.5 vol % or more. Further, when the proportion of Fe₇₀Co₃₀ of the second and third soft magnetic layers was in a range higher than that of the first and fourth soft magnetic layers (Examples 2-11 and 2-12), the SNR was maintained “good (Δ)”. However, the SNR was rated as “no good (x)” when the proportion of Fe₇₀Co₃₀ of the second and third soft magnetic layers was equal to or in a range lower than that of the first and fourth soft magnetic layers (Examples 2-9 and 2-10).

In Examples 2-13 to 2-16, while the composition of the second and third soft magnetic layers was the same 85 vol % of Fe₇₀Co₃₀, 12 vol % of Ta, and 3 vol % of B, the proportion of Fe₇₀Co₃₀ of the first and fourth soft magnetic layers was varied from 82 vol % to 87 vol %. Here, the squash resistance was maintained in the “excellent (O)” range in all of the Examples 2-13 to 2-16. However, when the proportion of Fe₇₀Co₃₀ of the first and fourth soft magnetic layers was higher than 83 vol %, the SNR fell out of the “excellent (O)” range. As shown, when the proportion of Fe₇₀Co₃₀ of the second and third soft magnetic layers was 85 vol %, the squash resistance was maintained in the “excellent (O)” range in all samples. Further, when the proportion of Fe₇₀Co₃₀ of the second and third soft magnetic layers was in a range higher than that of the first and fourth soft magnetic layers (Examples 2-13 and 2-14), the SNR was maintained “excellent (O)” or “good (Δ)”. However, the SNR was rated as “no good (x)” when the proportion of Fe₇₀Co₃₀ of the second and third soft magnetic layers was equal to or in a range lower than that of the first and fourth soft magnetic layers (Examples 2-15 and 2-16).

In Examples 2-17 to 2-20, while the composition of the second and third soft magnetic layers was the same 80 vol % of Fe₇₀Co₃₀, 15 vol % of Ta, and 5 vol % of B, the proportion of Fe₇₀Co₃₀ of the first and fourth soft magnetic layers was varied from 85 vol % to 80 vol %. Here, the SNR fell out of the “excellent (O)” range when the proportion of Fe₇₀Co₃₀ of the first and fourth soft magnetic layers was equal to or higher than 83 vol %, and when the proportion of Fe₇₀Co₃₀ of the first and fourth soft magnetic layers was equal to or lower than 81 vol %, the squash resistance fell out of the “excellent (O)” range. As shown, Examples 2-17 to 2-20 all failed to achieve both SNR and squash resistance that are in a favorable “excellent (O)” range.

In Examples 2-21 to 2-25, SULs composed of a magnetic material containing Fe and Co and a dopant material containing one or a combination of elements including B, C, Ti, Zr, Hf, V, Nb, and Ta were investigated. As the results show, the magnetic recording medium achieved an SNR in the “excellent (O)” range while maintaining the squash resistance in the “excellent (O)” range when the proportion of the magnetic material containing Fe and Co of the second and third soft magnetic layers was higher than that of the first and fourth soft magnetic layers.

A comparison between Example 1 and Comparative Example 1, Examples 2-2 and 2-4, or 2-5 and 2-18, indicates that the SNR varies depending on the arrangement of the soft magnetic layers even though the combinations are the same. Namely, SNR fell out of the “excellent (O)” range when the compositions of the first and fourth soft magnetic layers and the second and third soft magnetic layers were inverted compared with the samples that had exhibited both excellent (O) squash resistance.

As the above results show, the magnetic recording medium achieved an SNR in the “excellent (O)” range while maintaining the squash resistance in the “excellent (O)” range when the proportion of the magnetic material containing Fe and Co of the second and third soft magnetic layers was higher than that of the first and fourth soft magnetic layers. In particular, when the proportion of the magnetic material containing Fe and Co of the second and third soft magnetic layers was 82.5 vol % or more, and the proportion of the magnetic material containing Fe and Co of the first and fourth soft magnetic layers was less than 82.5 vol %, both the squash resistance and SNR of the magnetic recording medium were maintained as “excellent (O)”.

Next, the results shown in Table 4 will be discussed.

One can see from the results shown in Table 4 that there is a trade-off relationship between relative permeability at 10 MHz and characteristic frequency of relative permeability (frequency when the relative permeability drops by 50% of the relative permeability at 10 MHz) in soft magnetic layers made of a magnetic material containing Fe and Co and a dopant material consisting of B and Ta, and that the soft magnetic layers having a higher relative permeability have a lower characteristic frequency of relative permeability.

A look at the proportion of the magnetic material containing Fe and Co shows that the relative permeability at 10 MHz increases with the increase in this proportion. As shown, the samples with a proportion of the magnetic material containing Fe and Co (Fe₇₀Co₃₀) of 82.5 vol % or more have a relative permeability of 700 or more.

The lower the proportion of the magnetic material containing Fe and Co, the higher the characteristic frequency of relative permeability. As shown, the samples with a proportion of the magnetic material containing Fe and Co (Fe₇₀Co₃₀ of 82 vol % or less have a characteristic frequency of relative permeability of 1000 MHz or more.

The results shown in Tables 1 to 4 indicate that one requirement for satisfying both good squash resistance and SNR is that the first and fourth soft magnetic layers have a characteristic frequency of relative permeability higher than that of the second and third soft magnetic layers. Another requirement is that the first and fourth soft magnetic layers have a characteristic frequency of relative permeability of 1000 MHz or more, and the second and third soft magnetic layers have a relative permeability of 700 or more.

Tables 1 to 4 indicate that one requirement for satisfying both good squash resistance and SNR is that the first and fourth soft magnetic layers have a characteristic frequency of relative permeability higher than that of the second and third soft magnetic layers. Another requirement is that the first and fourth soft magnetic layers have a characteristic frequency of relative permeability of 1000 MHz or more, and the second and third soft magnetic layers have a relative permeability of 700 or more.

As demonstrated above, with the structure of the soft magnetic underlayer of the present invention, the magnetic recording medium could satisfy both requirements of squash resistance and SNR.

What is claimed is:

1. A magnetic recording medium comprising at least a soft magnetic underlayer and a magnetic recording layer on a non-magnetic substrate,
the soft magnetic underlayer having a structure including a first soft magnetic layer, a second soft magnetic layer, an exchange coupling control layer, a third soft magnetic layer, and a fourth soft magnetic layer stacked in this order from a non-magnetic substrate side,
the first and fourth soft magnetic layers both having a characteristic frequency of relative permeability higher than a higher one of characteristic frequencies of relative permeability of the second and third soft magnetic layers, the characteristic frequency of relative permeability being a frequency at which the relative permeability drops by 50% of the relative permeability at 10 MHz, and
the second and third soft magnetic layers both having a relative permeability higher than a higher one of the relative permeabilities of the first and fourth soft magnetic layers.

2. The magnetic recording medium according to claim 1, wherein the first to fourth soft magnetic layers of the soft magnetic underlayer include
(i) a magnetic material containing Fe and Co, and
(ii) a dopant material containing one or a combination of elements selected from B, C, Ti, Zr, Hf, V, Nb, and Ta.

3. The magnetic recording medium according to claim 1, wherein the first and fourth soft magnetic layers have a same composition and a same thickness, and the second and third soft magnetic layers have a same composition and a same thickness.

4. The magnetic recording medium according to claim 1, wherein the first and fourth soft magnetic layers have a characteristic frequency of relative permeability of 1000 MHz or more, and the second and third soft magnetic layers have a relative permeability of 700 or more.

5. A magnetic recording medium comprising at least a soft magnetic underlayer and a magnetic recording layer on a non-magnetic substrate,
the soft magnetic underlayer having a structure including a first soft magnetic layer, a second soft magnetic layer, an exchange coupling control layer, a third soft magnetic layer, and a fourth soft magnetic layer stacked in this order from a non-magnetic substrate side,
the four soft magnetic layers being a combination of soft magnetic layers made of (i) a magnetic material containing Fe and Co, and (ii) a dopant material containing one or a combination of elements selected from B, C, Ti, Zr, Hf, V, Nb, and Ta, and
the second and third soft magnetic layers both having a higher proportion of the magnetic material containing Fe and Co than that of both of the first and fourth soft magnetic layers.

6. The magnetic recording medium according to claim 5, wherein the second and third soft magnetic layers of the soft magnetic underlayer have a proportion of the magnetic material containing Fe and Co of 82.5 vol % or more, and the first and fourth soft magnetic layers have a proportion of the magnetic material containing Fe and Co of less than 82.5 vol %.

7. A magnetic recording medium, comprising:
a substrate; and
a plurality of layers formed on the substrate in a predetermined order, the predetermined order being based at least partly on a characteristic frequency of relative permeability property of respective ones of the layers;
wherein the characteristic frequency of relative permeability property is defined at least partly in terms of a relative permeability value at a given frequency.

8. The magnetic recording medium of claim 7, wherein a characteristic frequency of relative permeability of at least one of the layers is higher than a characteristic frequency of relative permeability of at least one other of the layers.

9. The magnetic recording medium of claim 8, wherein a relative permeability of the at least one other of the layers is higher than a relative permeability of the at least one of the layers.

10. The magnetic recording medium of claim 9, wherein the plurality of layers includes first, second, third and fourth layers, the first layer closest of the first through fourth layers to the substrate and the fourth layer furthest from the substrate of the first through fourth layers, and the first and fourth layers having a higher characteristic frequency of relative permeability than the second and third layers.

11. The magnetic recording medium of claim 10, wherein the second and third layers have a higher relative permeability than a relative permeability of the first and fourth layers.

12. The magnetic recording medium of claim 11, wherein the first through fourth layers include a magnetic material.

13. The magnetic recording medium of claim 12, wherein the magnetic material includes at least one of Fe or Co.

14. The magnetic recording medium of claim 12, wherein the first through fourth layers further include a dopant material.

15. The magnetic recording medium of claim 14, wherein the dopant material includes at least one of B, C, Ti, Zr, Hf, V, Nb, or Ta.

16. The magnetic recording medium of claim 10, further comprising an exchange coupling control layer between the second and third layers to facilitate antiferromagnetic coupling among the plurality of layers.

17. The magnetic recording medium of claim 12, wherein the second and third layers contain more of the magnetic material than do the first and fourth layers.

18. The magnetic recording medium of claim 10, further comprising a magnetic recording layer further from the substrate than the fourth layer.

19. The magnetic recording medium of claim 18, further comprising a protective layer formed on the magnetic recording layer.

20. The magnetic recording medium of claim 7, wherein the characteristic frequency of relative permeability property corresponds to a frequency at which relative permeability is reduced by substantially 50% of relative permeability at 10 MHz.
